(19) United States
(12) Patent Application Publication
(10) Pub. No.: US 2010/0151222 A1
(43) Pub. Date: Jun. 17, 2010

(54) MULTILAYER COMPOSITE FOIL

(75) Inventors: Arndt Kremers, Wurselen (DE); Michael Herrmann, Koln (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/604,885

(22) Filed: Oct. 23, 2009

(30) Foreign Application Priority Data
Oct. 27, 2008 (EP) 08167641.3

(51) Int. Cl. B32B 5/00; B32B 33/00; B29C 47/06

(52) U.S. Cl. 428/220; 428/354; 264/173.16

(57) ABSTRACT

Novel multilayer composite foils are provided and are composed of at least three layers, comprising an adhesive layer composed of at least one α-olefin-vinyl acetate copolymer having vinyl acetate content of ≧40% by weight, based on the total weight of the α-olefin-vinyl acetate copolymer. The said multilayer composite foils are suitable for the packaging of products and for use as protective foil. Production can be achieved by way of blown-film extrusion.

The present invention relates to a multilayer composite foil composed of at least three layers, comprising an adhesive layer composed of at least one α-olefin-vinyl acetate copolymer having vinyl acetate content of ≧40% by weight, based on the total weight of the α-olefin-vinyl acetate copolymer. The invention further relates to a process for the production of the said multilayer composite foils by way of blown-film extrusion, and also to the use of the multilayer composite foils for the packaging of products and as protective foil.

Multilayer composite foils are currently used in many different applications. The packaging industry, for food or drink, or for pharmaceutical products, provides a large market with requirements that start with simple packaging foils and extend to hygienic foils or laminated foils. There is now also a high level of demand for what are known as protective foils for a very wide variety of surfaces. These protective foils are intended to protect the surfaces of various materials from external effects, in particular contamination, and mechanical damage. A decisive factor for suitability as a protective foil is that the said protective foil has adequate adhesion on the surface to be protected, but at the same time can easily in turn be removed by peeling, without leaving any residues on the surface.

There are various types of known self-adhesive protective foils having a plurality of sublayers:

DE 195 32 220 A1 describes by way of example self-adhesive protective foils for use in the automobile sector. These foils involve 2-layer foils in which a self-adhesive mass composed of polyethylene-vinyl acetate, characterized via the loss angle tan δ measured under different conditions, has been applied to a backing foil, preferably composed of polyethylene and/or polypropylene. The said 2-layer foils are produced exclusively by applying the self-adhesive mass to the backing foil on a coating line using a spreader bar. No other methods of production are disclosed.

DE 196 35 704 A1 discloses self-adhesive protective foils in which a self-adhesive mass composed of polyvinyl acetate is applied to a backing foil. The backing foil is based on a specific mixture of polyethylene, polypropylene, titanium dioxide and light stabilizers in precisely defined quantitative proportions. The self-adhesive mass is based on polyvinyl acetate having vinyl acetate content of from 40 mol % to 80 mol %. A further disclosure is that there can be, applied between backing foil and self-adhesive mass, a primer composed of polyethylene-vinyl acetate having a proportion of from 30 to 50 parts by weight of polyethylene and from 0.3 to 0.7 part by weight of light stabilizers. The composite foil is produced by applying the self-adhesive mass to the backing foil either from the solution or from the melt. If the backing foil has the abovementioned primer, it is also possible that the backing foil is coextruded with the primer. No other possibilities for the production process are disclosed.

DE 197 42 805 A1 describes another self-adhesive protective foil based on a backing foil and on an adhesive mass. The backing foil is based on polyolefins, e.g. polyethylene, polypropylene or a mixture thereof. The adhesive layer is based on a copolymer which is in essence amorphous, of at least two different α-C₂-C₁₂-olefin monomers, and also on at least one diene as comonomer, where the proportion of no α-olefin is to be 75 mol % or above. 1,4-Hexadiene, dicyclopentadiene and in particular 5-ethylidene-2-norbornene (ENB) are described as dienes. The proportion of the further comonomers in the polymer of the adhesive layer, e.g. vinyl acetate, is intended to be below 30 mol %, preferably below 20 mol %, but it is preferable that the polar monomer is entirely omitted in the adhesive mass. There can optionally be an adhesion-promoter layer between backing foil and adhesive mass, and the said layer involves a polymer composed of mainly olefinic monomers. Preferred materials mentioned as a basis for the adhesion promoter are thermoplastic EPM elastomers or thermoplastic EPDM elastomers, and ionomers based on ethylene-(meth)acrylic acid copolymers or on maleic-anhydride-modified polyolefins. The adhesion promoter can be applied on the base foil via normal coextrusion with the base foil or via coextrusion with base foil and adhesive or via coating (by means of a spreader bar). Example 3 produces a 3-layer foil via normal coextrusion, using a polyolefin-based backing layer and a terpolymer of ethylene (E), propylene (P) and ENB as adhesive outer layer. The adhesion-promoter layer is a mixture of the E/PE/ENB terpolymer and a recycled protective foil from Example 1. No other methods of production are described for the protective foils.

DE 199 23 780 A1 describes a self-adhesive protective foil, the backing foil of which comprises at least one unstretched polypropylene block copolymer, while the adhesive layer comprises, for example, an ethylene-vinyl acetate copolymer having vinyl acetate content of at least 40% by weight, preferably from 55 to 70% by weight. Normal coextrusion can be used to produce a 3-layer composite foil with intermediate adhesion-promoter layer, with backing foil and adhesive layer. The production process described in Example 3 for the protective foil via coextrusion uses an adhesion-promoter layer based on Escorene® Ultra UL 00728, the vinyl acetate content of which is 27.5% by weight. No other methods of production are described for the protective foils.

DE 199 54 700 A1 describes a 3-layer self-adhesive foil composed of backing layer, primer and adhesive layer. The backing layer uses polyolefins, and the primers used comprise grades of EVA with VA content of from 20 to 30% by weight. The adhesive layer is based on a polyvinyl acetate having vinyl acetate content in the range from 40 to 80% by weight. However, it is essential that the polyvinyl acetate in the adhesive masses is blended with from 1 to 35% by weight of a polyether. The adhesive mass can be processed either from solution or else from the melt, in the form of hotmelt, or via normal coextrusion. No other methods of production are described for the protective foils.

DE 100 07 060 A1 discloses a self-adhesive protective film with a backing layer (a thermoplastic polyolefin film) composed of one or more sublayers, and with an adhesive layer, where the adhesive layer is essentially composed of a polar component A (comprising a polyvinyl acetate having vinyl acetate content of from 40 to 80% by weight) and a non-polar component B (an α-olefin-based homo- or copolymer). The adhesion-promoter layer used in DE 100 07060 A1 comprises a mixture of a polypropylene block copolymer and a polyethylene-vinyl acetate having 27.5% by weight of vinyl acetate (Escorene® Ultra UL 00728). The only production method mentioned, in paragraph [0039], is normal three-layer flat-film coextrusion, which is also disclosed in the other abovementioned references.

DE 101 23 985 A1 describes another self-adhesive protective foil for glass surfaces with porous SiO₂ antireflective layer. This likewise involves a 3-layer composite foil composed of backing layer (polyolefin-based) and adhesive layer, in which there must be polyalkylene glycols present as additive, alongside the polyethylene-vinyl acetate having vinyl acetate content of at least 40% by weight. The primer (adhesion-promoter layer) used comprises EVA polymers having vinyl acetate content of from 20 to 50% by weight. In the examples, the adhesive mass is applied from solution to the pretreated backing layer. Another possibility mentioned is application from the melt, in the form of hotmelt, or again via normal coextrusion. No other methods of production are described for the protective foils.

DE 199 54 701 A1 and DE 103 03 537 A1 disclose further self-adhesive surface-protection foils with a backing layer composed of polypropylene or of propylene-ethylene copolymers and with a self-adhesive mass composed of polyethylene-vinyl acetate having vinyl acetate content of from 40 to 80% by weight and a polyether. The primer layer can, as in DE 101 23 985 A1, encompass an EVA polymer having vinyl acetate content of from 20 to 50% by weight. DE 199 54 701 A1 and DE 103 03 537 A1 do not add anything to the production processes described in DE 101 23 985 A1.

DE 103 18 151 A1 discloses self-adhesive protective foils with a backing layer composed of a thermoplastic film, preferably composed of polyolefins, and with a self-adhesive layer composed of butyl rubber which has defined isoprene content of up to 1.8 mol %. The adhesive layer based on butyl rubber is described as advantageous in comparison with the known polar ethylene-vinyl acetate adhesive masses, because of its non-polarity. There is also optionally an adhesion-promoter layer arranged between the adhesive layer and the thermoplastic foil layer. This involves a low-density polyolefin, blends of various polyolefins or blends of the components of backing layer and adhesive mass. The production process can use calenders and blowing lines, but operations preferably use cast lines, using the cast-film process.

DE 10 2005 009 664 A1 discloses multilayer composite systems composed of at least two foils of chemically different structures with low adhesion to one another and an adhesion promoter which involves an ethylene-vinyl acetate copolymer having vinyl acetate content in the range from 35 to 85% by weight. Materials used for the layers of the foil are polyesters, and also polyamides, cycloolefin copolymers, ethylene-vinyl alcohol, PVC and polystyrene. The foils can be produced either by way of a film extruder or else via blown-film extrusion or via extrusion coating of the multilayer foils onto existing foil composites.

In summary it can be stated that there is a wide variety of known multilayer composite foils. A disadvantage is that complex blends of the base polymers are often “composed” with a very wide variety of other substances or additives in the respective layers, making the overall process, and also the resultant composite foil, complicated and expensive. A further disadvantage is that these multilayer composite foils have hitherto been mainly produced either by way of cast-film processes (known as “cast-extrusion” processes), by applying the adhesive mass either from solution or from the melt to the backing foil (optionally previously provided with primer or with adhesion-promoter layer), or else by carrying out 3-layer flat-film coextrusion. The cast-film process is time-consuming, since the layers are cast successively, and it is therefore relatively unattractive from an economic point of view. The 3-layer flat-film coextrusion process is disadvantageous to the extent that it is subject to limitations when production of foils with very low layer thicknesses is involved, and space-time yields are also not yet entirely satisfactory. Nor can the known processes produce all of the desired types of multilayer foils.

In the light of the large requirement for multilayer composite foils, the object of the present invention therefore consisted in providing an improved and simpler production process, and also resultant novel multilayer composite foils.

This object is achieved via a multilayer composite foil composed of at least three layers comprising
1) at least one adhesive outer layer composed of at least one α-olefin-vinyl acetate copolymer having vinyl acetate content of ≧40% by weight, preferably ≧45% by weight, based on the total weight of the α-olefin-vinyl acetate copolymer (1),
2) at least one middle layer located thereunder and based on an α-olefin-vinyl acetate copolymer having vinyl acetate content of in the range from 12 to 20% by weight, preferably in the range from 12 to less than 20% by weight, based on the total weight of the α-olefin-vinyl acetate copolymer (2) and
3) at least one backing layer located thereunder and based on a polyolefin.

The multilayer composite foil of the invention preferably involves a 3-layer foil composed of an outer layer, a middle layer and a backing layer.

The invention also provides a process for the production of the said multilayer composite foils via blown-film extrusion, by transporting each of the following materials: the α-olefin-vinyl acetate copolymer having vinyl acetate content of ≧40% by weight (1), the α-olefin-vinyl acetate copolymer having vinyl acetate content in the range from 12 to 20% by weight (2), and also the polyolefin (3) by way of its own extruder to the main operating region of a blown-film line, where they are moulded via a die to give the multilayer composite foil of the invention.

The invention further provides the use of the multilayer composite foil of the invention for the packaging of products and for protecting the surfaces of materials.

Adhesive Outer Layer (1):

The α-olefin-vinyl acetate copolymers used according to the invention feature high vinyl acetate contents of ≧40% by weight, based on the total weight of the α-olefin-vinyl acetate copolymer, preferably vinyl acetate contents of ≧45% by weight, in each case based on the total weight of the α-olefin-vinyl acetate copolymer. The vinyl acetate content of the α-olefin-vinyl acetate copolymers used according to the invention is usually from ≧40% by weight to 98% by weight, preferably from ≧45% by weight to 90% by weight and particularly preferably from ≧45% by weight to 80% by weight, and the α-olefin content is correspondingly from 2% by weight to ≦60% by weight, preferably from 10% by weight to ≦55% by weight and particularly preferably from 20% by weight to ≦55% by weight, where the total amount of vinyl acetate and α-olefin is 100% by weight.

In another embodiment, the α-olefin-vinyl acetate copolymer (1) used according to the invention can comprise, alongside the repeat units based on the α-olefin and vinyl acetate, one or more other comonomer units, the result therefore being terpolymers, e.g. based on vinyl esters and/or on (meth)acrylates as termonomers. The proportion of the other comonomer units, if indeed other comonomer units are present in the α-olefin-vinyl acetate copolymer, is up to 10% by weight, based on the total weight of the α-olefin-vinyl acetate copolymer, with a corresponding reduction in the proportion of the monomer units based on the α-olefin. It is therefore possible, for example, to use α-olefin-vinyl acetate copolymers which are composed of from ≧40% by weight to 98% by weight, preferably from ≧45% by weight to 90% by weight, of vinyl acetate, from 2% by weight to ≦60% by weight, preferably from 10% by weight to ≦55% by weight, of α-olefin and from 0 to 10% by weight of at least one other comonomer, where the total amount of vinyl acetate, α-olefin and the other comonomer is 100% by weight.

α-Olefins that can be used in the α-olefin-vinyl acetate copolymers used according to the invention are any of the known α-olefins. It is preferable that the α-olefin has been selected from ethene, propene, butene, in particular n-butene and isobutene, pentene, hexene, in particular 1-hexene, heptene and octene, in particular 1-octene, but it is also possible to use higher homologues of the α-olefins mentioned. The α-olefins can moreover bear substituents, in particular C₁-C₅-alkyl moieties. However, it is preferable that the α-olefins do not bear any further substituents. It is moreover possible to use mixtures of two or more different α-olefins in the α-olefin-vinyl acetate copolymers used according to the invention. However, it is preferable not to use mixtures of various α-olefins. Preferred α-olefins are ethene and propene. It is particularly preferable to use an ethylene-vinyl acetate copolymer in the multilayer composite foil of the invention.

The α-olefin-vinyl acetate copolymer (1), preferably ethylene-vinyl acetate copolymer, is produced by a solution-polymerization process at a pressure of from 300 to 500 bar, preferably at a pressure at which free-radical initiators are generally used.

The ethylene-vinyl acetate copolymers (1) preferably used according to the invention, having the stated high vinyl acetate contents, are usually referred to as EVM copolymers, where the “M” in the abbreviation indicates the saturated backbone of the methylene main chain of the EVM.

Suitable production processes for the α-olefin-vinyl acetate copolymers used according to the invention are mentioned by way of example in EP-A 0 341 499, EP-A 0 510 478 and DE-A 38 25 450.

The α-olefin-vinyl acetate copolymers (1) used according to the invention, preferably ethylene-vinyl acetate copolymers, generally have MFI values (g/10 min) of from 1 to 40, preferably from 1 to 10 and particularly preferably from 2 to 6, measured to ISO 1133 at 190° C. using a load of 21.1 N.

Mooney viscosities to DIN 53 523 ML 1+4 are generally from 3 to 50 Mooney units, preferably from 4 to 35 Mooney units, at 100° C.

The number average molecular weight is generally from 5000 g/mol to 200 000 g/mol, preferably from 10 000 g/mol to 100 000 g/mol, determined by means of GPC.

Particularly preferred ethylene-vinyl acetate copolymers (1) used for he production of the multilayer composite foil of the invention are those by way of example available commercially as Levapren® or Levamelt® from Lanxess Deutschland GmbH, examples of grades being Levamelt® 450, Levamelt® 600, Levamelt® 700, Levamelt® 800 and Levamelt® 900, having vinyl acetate content of 45±1.5% by weight, 60±1.5% by weight, 70±1.5% by weight, 80±2% by weight and, respectively, 90±2% by weight.

It is preferable that the adhesive layer does not comprise any polyalkylene glycols, polyethers or derivatives thereof as additives alongside the α-olefin-vinyl acetate copolymer (1).

Small amounts of polyethylene can also optionally be added to the α-olefin-vinyl acetate copolymer (1) having vinyl acetate content of ≧40% by weight, based on the total weight of the α-olefin-vinyl acetate copolymer, in order to optimize properties, and this can reduce adhesion values.

The α-olefin-vinyl acetate copolymers (1) used according to the invention have preferably not been crosslinked.

Middle Layer:

Below the adhesive outer layer (1), the multilayer composite foil of the invention has at least one middle layer based on an α-olefin-vinyl acetate copolymer (2) having vinyl acetate content in the range from 12 to 20% by weight, preferably from 12 to less than 20% by weight, particularly preferably from 15 to 19% by weight and with particular preference from 16 to 18% by weight, based on the total weight of the α-olefin-vinyl acetate copolymer.

This middle layer, also called “tie layer” or “compatibilizer”, has the function of an adhesion promoter acting between adhesive layer (1) and backing layer (3), i.e. is intended to ensure good coupling between the adhesive outer layer and the backing layer(s) located thereunder.

For the definition of the α-olefin in this middle layer, reference is made to the definition of the α-olefin for the adhesive outer layer (1).

These α-olefin-vinyl acetate copolymers (2) having vinyl acetate content in the range from 12 to 20% by weight, based on the total weight of the α-olefin-vinyl acetate copolymer, can be produced by methods familiar to the person skilled in the art. They are usually produced via bulk polymerization at a pressure in the range from 1000 to 3000 bar and at a temperature in the range from 150 to 350° C. Polymerization processes of this type are widely described in the literature.

α-Olefin-vinyl acetate copolymers having vinyl acetate content in the range from 12 to 20% by weight, based on the total weight of the α-olefin-vinyl acetate copolymer, are moreover commercially available by way of example as Escorene™ from ExxonMobil, and also Elvaloy® from DuPont.

The α-olefin-vinyl acetate copolymers (2) can be used either in pure form or else in a blend with other polar olefin copolymers. The amounts of other polar olefin copolymers that can be added here are up to 50 parts by weight, preferably from 0.1 to 5 parts by weight, based on the α-olefin-vinyl acetate copolymers (2). Examples of materials that can be used are ethylene-acrylate copolymers, ethylene-acrylic acid copolymer or ethylene-methacrylic acid copolymer, and these can be varied in terms of comonomer content and viscosity in such a way as to obtain, as a function of requirement, adhesive layers with high cohesion.

Back Layer:

The multilayer composite foil of the invention has, below the middle layer(s), at least one back layer or backing layer based on a polyolefin. This preferably involves a thermoplastic foil layer. It preferably involves a polyethylene layer or polypropylene layer, or a layer composed of a mixture of polyethylene and polypropylene, particular preference being given to LDPE layers, metallocene-PE layers and LLDPE layers.

In order to make the back layer weathering-resistant, it can be advisable to add light stabilizers. These light stabilizers for polyolefins are known to the person skilled in the art from the literature. By way of example, the materials known as HALS light stabilizers are suitable. It is moreover possible to use antioxidants. It can also be advisable to use UV absorbers and ageing stabilizers, as a function of the planned use of the multilayer composite foil.

The thickness of the multilayer composite foil of the invention is usually in the range from 20 to 150 μm, preferably in the range from 25 to 110 μm and particularly preferably in the range from 50 to 100 μm, wherein
the thickness of the adhesive outer layer based on the α-olefin-vinyl acetate copolymer having vinyl acetate content of ≧40% by weight, based on the total weight of the α-olefin-vinyl acetate copolymer is usually in the range from 2.5 to 40 μm, preferably from 2.5 to 30 μm, particularly preferably from 5 to 25 μm,
the thickness of the middle layer located thereunder and based on an α-olefin-vinyl acetate copolymer having vinyl acetate content in the range from 12 to 20% by weight, preferably from 12 to less than 20% by weight, based on the total weight of the α-olefin-vinyl acetate copolymer, is usually in the range from 2.5 to 40 preferably from 2.5 to 30 μm and particularly preferably from 5 to 25 μm, and
the thickness of the back layer located thereunder and based on a polyolefin is usually in the range from 15 to 70 μm, preferably from 15 to 50 μm and in particular from 40 to 50 μm.

Production Process:

The process of the invention for the production of the multilayer composite foil involves a blown-film extrusion process. The three essential starting components, i.e. the α-olefin-vinyl acetate copolymer having vinyl acetate content of ≧40% by weight (1), the α-olefin-vinyl acetate copolymer having vinyl acetate content in the range from 12 to 20% by weight (2), and also the polyolefin (3), are heated in three separate extruders and kneaded and introduced by way of three dies to the blown-film line, by means of which all three of the starting components (1)-(3) are moulded to a foil, with introduction of air, the foil then being cooled and wound up or plaited.

In the first step, each of the three starting components is metered into an extruder, in which the pressure generated by the screw causes homogenization and continuous transport of the material, with heating. The extruders transport the respective component to annular dies, which by virtue of homogeneous melt distribution produce a tubular film, which is expanded and cooled by simultaneous introduction of air. Downstream stages involving transport and deflection cool the tubular film sufficiently to permit wind-up of the same.

During the wind-up procedure, care has to be taken to set the process parameters appropriately so that the foil does not become electrostatically charged or form creases.

The process of the invention can also be used for the production of multilayer composite foils which have more than 3 layers, and in this case further extruders are correspondingly added to the system in order to introduce the additional components required.

The multilayer composite foil can be produced on the blown-film lines constructed and marketed by way of example by the following companies: Kuhne, Kiefel, Reifenhaüser, and also Windmöller & Hölscher.

The temperatures of the three extruders here are set in such a way that the viscosities of the materials are approximately within the same range. Shear rates have to be considered here.

The multilayer composite foils of the invention feature high UV resistance, good resistance to high and low temperatures, high toughness providing protection from mechanical effects, good extensibility values, adequate adhesion in applications on curved surfaces, and no residues on peeling of the protective foil from the substrate. Production on an industrial scale, and continuously by way of blown-film extrusion, was hitherto impossible and substantially increases cost-effectiveness. The protective foils of the invention are unlike the self-adhesive protective foils known from the prior art in that it is not essential to use additional additives alongside the base polymers in the individual layers of the foil in order to achieve the desired properties.

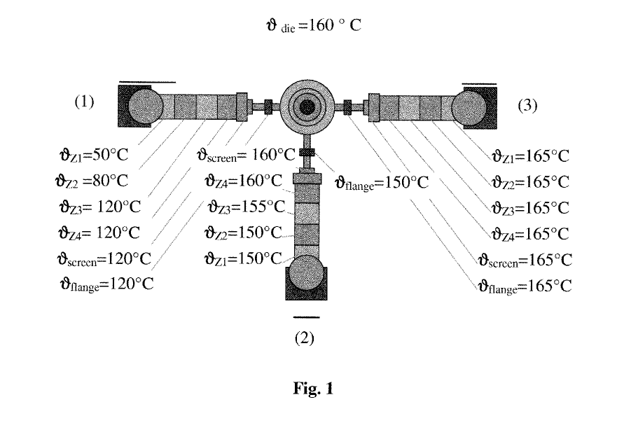

FIG. 1:

FIG. 1 shows the arrangement of the three extruders with the respective temperature settings used in Example 1 to produce the multilayer composite foil of the invention. The abbreviations (1), (2) and (3) indicate the extruder into which each of the three components was introduced.

Key to FIG. 1:
(1) Levamelt® 450 (Lanxess Deutschland GmbH)
(2) Ethylene-vinyl acetate copolymer having vinyl acetate content of 18% by weight, based on the total weight of the α-olefin-vinyl acetate copolymer (2) (Escorene®, ExxonMobil Chemical) and
(3) the backing layer located thereunder and composed of polyethylene.

The stated temperatures θ . . . are the temperatures of the respective extruder section or, respectively, of the adjacent modules of the blown-film line.

### EXAMPLES

The layers stated in Table 1 were used to produce a multilayer composite foil of the invention, via blown-film extrusion.

TABLE 1

| | | | | | Layer |
|---|---|---|---|---|---|
| Layer | Material | | MFI¹ | Density | thickness |
| Adhesive layer | EVM | Levamelt ® 450 | 6 g/10 min | 0.99 g/cm³ | 10 μm |
| (“Adhesive | | (VA content = 45% by | | | |
| layer”) | | wt.) | | | |
| Adhesion- | EVA | VA content = 18% by | 1.7 g/10 min | 0.940 g/cm³ | 10 μm |
| promoter layer | | wt. | | | |
| (“Tie layer”) | | Escorene ®, | | | |
| | | ExxonMobil Chemical | | | |
| Back layer | PE | Sabic 0863F | 0.85 g/10 min | 0.922 g/cm³ | 40 μm |
| (“Backing”) | | | | | |

¹measured at 190° C. using 21.2 N

Blown-Film Line and Method:

A blown-film line from Kiefel was used to produce the multilayer composite foil. Table 2 collates the data for the three Kirion® extruders used.

TABLE 2

| | Extruder A | Extruder B | Extruder C |
|---|---|---|---|
| Type of extruder | 70F30D VLS | 80F30D VLS | 70F30D VLS |
| Diameter of | 70 | 80 | 70 |
| screw [mm] | | | |
| Layer | Backing layer | Adhesion- | Adhesive mass |
| | | promoter | |
| | | layer | |
| Ratio by weight [%] | 16.7% | 66.7% | 16.7% |
| Material | EVA | PE | Levamelt ® 450 |

The operating parameters and operating temperatures are given in Tables 3 and 4 below.

TABLE 3

| | Extruder A | Extruder B | Extruder C |
|---|---|---|---|
| Screw speed [1/min] | 61.6 | 73.1 | 78.0 |
| Output [kg/min] | 42.2 | 169.0 | 45.3 |
| Efficiency [%] | 16.0 | 38.0 | 18.0 |
| Melt temperature | 176 | 187 | 143 |
| θₘ [° C.] | | | |
| Melt pressure pₘ [bar] | 185.0 | 313.0 | 190.0 |
| Layer thickness h₁ | 9.9 | 40.3 | 10.0 |
| [μm] | | | |
| Film weight [g/m] | 23.45 | 93.90 | 25.18 |

TABLE 4

| | Extruder A | Extruder B | Extruder C |
|---|---|---|---|
| Temperature θ_{Z1} [° C.] | 150 | 165 | 80 |
| Temperature θ_{Z2} [° C.] | 150 | 165 | 90 |
| Temperature θ_{Z3} [° C.] | 155 | 165 | 115 |
| Temperature θ_{Z4} [° C.] | 160 | 165 | 120 |
| Temperature θ_{screen} [° C.] | 160 | 165 | 120 |
| Temperature θ_{flange} [° C.] | 150 | 165 | 120 |

| | |
|---|---|
| Temperature θ_{die} [° C.] | 160 |

FIG. 1 shows the allocation of the temperatures mentioned in Table 4 to the respective extruder section.

1. Multilayer composite foil composed of at least three layers comprising
1) at least one adhesive outer layer composed of at least one α-olefin-vinyl acetate copolymer having vinyl acetate content of ≧40% by weight, preferably ≧45% by weight, based on the total weight of the α-olefin-vinyl acetate copolymer (1),
2) at least one middle layer located thereunder and based on an α-olefin-vinyl acetate copolymer having vinyl acetate content of in the range from 12 to 20% by weight, preferably in the range from 12 to less than 20% by weight, based on the total weight of the α-olefin-vinyl acetate copolymer (2) and
3) at least one backing layer located thereunder and based on a polyolefin.

2. Multilayer composite foil according to claim 1, in which the adhesive outer layer (1) is composed of at least one α-olefin-vinyl acetate copolymer having vinyl acetate content of ≧45% by weight, based in each case on the total weight of the α-olefin-vinyl acetate copolymer.

3. Multilayer composite foil according to claim 1, in which the adhesive outer layer (1) is composed of at least one α-olefin-vinyl acetate copolymer, preferably ethylene-vinyl acetate copolymer, having vinyl acetate content of from ≧40% by weight to 98% by weight, preferably from ≧45% by weight to 90% by weight and particularly preferably from ≧45% by weight to 80% by weight, and having α-olefin content, preferably ethylene content, of from 2% by weight to ≦60% by weight, preferably from 10% by weight to ≦55% by weight and particularly preferably from 20% by weight to ≦55% by weight, where the total amount of vinyl acetate and α-olefin, preferably ethylene, is 100% by weight.

4. Multilayer composite foil according to claim 1, in which the adhesive outer layer (1) is composed of at least one α-olefin-vinyl acetate copolymer, preferably ethylene-vinyl acetate copolymer, with MFI value (g/10 min) of from 1 to 40, preferably from 1 to 10, particularly preferably from 2 to 6, measured to ISO 1133 at 190° C. and using a load of 21.1 N.

5. Multilayer composite foil according to claim 1, in which the adhesive outer layer (1) is composed of at least one α-olefin-vinyl acetate copolymer, preferably ethylene-vinyl acetate copolymer, with Mooney viscosity to DIN 53 523 ML 1+4 in the range from 3 to 50 Mooney units, preferably from 4 to 35 Mooney units, at 100° C.

6. Multilayer composite foil according to claim 1, in which the adhesive outer layer (1) is composed of at least one α-olefin-vinyl acetate copolymer, preferably ethylene-vinyl acetate copolymer, with number-average molar mass in the range from 5000 g/mol to 200 000 g/mol and preferably from 10 000 g/mol to 100 000 g/mol, determined by means of GPC.

7. Multilayer composite foil according to claim 1, in which the adhesive outer layer (1) is composed of at least one α-olefin-vinyl acetate copolymer, preferably ethylene-vinyl acetate copolymer, which has not been crosslinked.

8. Multilayer composite foil according to claim 1, in which the middle layer is based on an α-olefin-vinyl acetate copolymer (2) having vinyl acetate content in the range from 12 to 20% by weight, preferably from 12 to less than 20% by weight, particularly preferably from 15 to 19% by weight and with particular preference from 16 to 18% by weight, based on the total weight of the α-olefin-vinyl acetate copolymer.

9. Multilayer composite foil according to claim 1, in which the back layer or backing layer involves a polyethylene or polypropylene layer, preferably an LDPE layer, metallocene-PE layer or LLDPE layer.

10. Multilayer composite foil according to claim 1 with thickness in the range from 20 to 150 μm, preferably in the range from 25 to 110 μm and particularly preferably from 50 to 100 μm, where
the thickness of the adhesive outer layer (1) based on the α-olefin-vinyl acetate copolymer having vinyl acetate content of ≧40% by weight, based on the total weight of the α-olefin-vinyl acetate copolymer is in the range from 2.5 to 40 μm, preferably from 2.5 to 30 μm, particularly preferably from 5 to 25 μm,
the thickness of the middle layer (2) located thereunder and based on an α-olefin-vinyl acetate copolymer having vinyl acetate content in the range from 12 to 20% by weight, preferably from 12 to less than 20% by weight, based on the total weight of the α-olefin-vinyl acetate copolymer, is in the range from 2.5 to 40 μm, preferably from 2.5 to 30 μm and particularly preferably from 5 to 25 μm, and
the thickness of the back layer (3) located thereunder and based on a polyolefin is in the range from 15 to 70 μm, preferably from 15 to 50 μm and in particular from 40 to 50 μm.

11. Process for the production of the multilayer composite foil according to claim 1, characterized in that it involves blown-film extrusion, where the α-olefin-vinyl acetate copolymer having vinyl acetate content of ≧40% by weight (1), the α-olefin-vinyl acetate copolymer having vinyl acetate content in the range from 12 to 20% by weight (2), and also the polyolefin (3) are transported by way of extruders to the main operating region of a blown-film line, where they are moulded through a die to give the multilayer composite foil.

12. A method for preparation of a multilayer composite foil according to claim 1 for the packaging of products and of protecting the surfaces of materials.
